(19) United States
(12) Patent Application Publication
(10) Pub. No.: US 2006/0016993 A1
(43) Pub. Date: Jan. 26, 2006

(54) IR remote plow control

(76) Inventor: Carlo Zovich, New Britain, CT (US)

Correspondence Address: RALPH E. SAUCIER SR., 1927 PIERCE WAY, BUFORD, GA, 30519, US

(21) Appl. No.: 10/895,300

(22) Filed: Jul. 21, 2004

(51) Int. Cl. G01J 5/00

(52) U.S. Cl. 250/338.1

(57) ABSTRACT

The IR Remote Plow Control gives the driver of a vehicle connected to a plow or a front-loading mechanism the ability to control its movement by an infra-red device that sends a frequency for movement of the plow or mechanism. The two remote IR transmitters mounted on the steering wheel column are put in a convenient location so as to not interrupt the driving of the vehicle. With the IR transmitters located in this position, the driver is able to move the plow or front-loading mechanism without taking his hands off the steering wheel. The Remote Control Box is simply wired to the vehicle's 12 volts system for power, and is connected to the servo motors of the mechanism in such a manner that no extra components are necessary to complete the setup of the IR Remote Plow Control.

The purpose of the IR Remote Plow Control is to have a mechanism for the driver of a plow, or any other vehicle with a front-loaded mechanism that requires control from the inside, to control the mechanism without taking his hands off the steering wheel. When the driver takes his hands off the steering wheel, he has a tendency to look down for the toggle or lever needed to move the front-loaded mechanism. When he does this, it distracts him by taking his eyes off the road and what is happening in front of him. By having the finger controlled remote buttons on the steering device, the driver can then move the front-loaded mechanism by pushing the button, thereby sending an IR signal to the electronic box moving the mechanism. The present situation is that it is difficult for any driver to plow because he has to use one hand to move the plow with the toggle switch or lever, and the other to shift, all while steering. The IR Remote Plow Control being wireless and on the steering wheel makes plowing and moving the plow a simple operation compared to before.

The Main Electronic Cabinet is set up to have a main incoming power source, a ground wire for safety, and an ignition wire, which would turn power on. The Main Electronic Cabinet could be mounted under the hood or under the dash of the vehicle. The IR Remote Plow Control would only operate when the vehicle is in operation, or when the ignition is turned on. The Main Electronic Cabinet would have (2) input IR sensors that would be operated from the steering column. There is also a safety switch to shut the unit down in case of emergency. The Main Electronic Cabinet would have a couple of relays that would be activated by the IR sensors which, in turn, would operate the servo motors of the plow, causing the plow to move up, down or sideways.

The simplicity of this tool intended by the inventor is so the manufacturers of a plow or some type of front loading mechanism can manufacture a product that would be safer for the operator to use. The product would also be simple enough that the consumer could purchase it and be able to install it on the mechanism without a lot of difficulty. This is possible because the IR Remote Plow Control is made with fewer moving parts, allowing the driver or the person installing the Remote Control Mechanism to install it without relative ease.

There are safety features built into the IR Remote Plow Control in case there is an emergency and the unit has to be shut down. The safety switch located inside the cab is a button that the operator can easily hit that will shut off the power to the IR Remote Plow Control. When the power is shut off, the servo motors plow mechanism automatically returns the plow to the upper position. There is also a fuse in the line. In case of a power build up, the fuse will pop, shutting down the IR Remote Plow Control.

Operating the IR Remote Plow Control

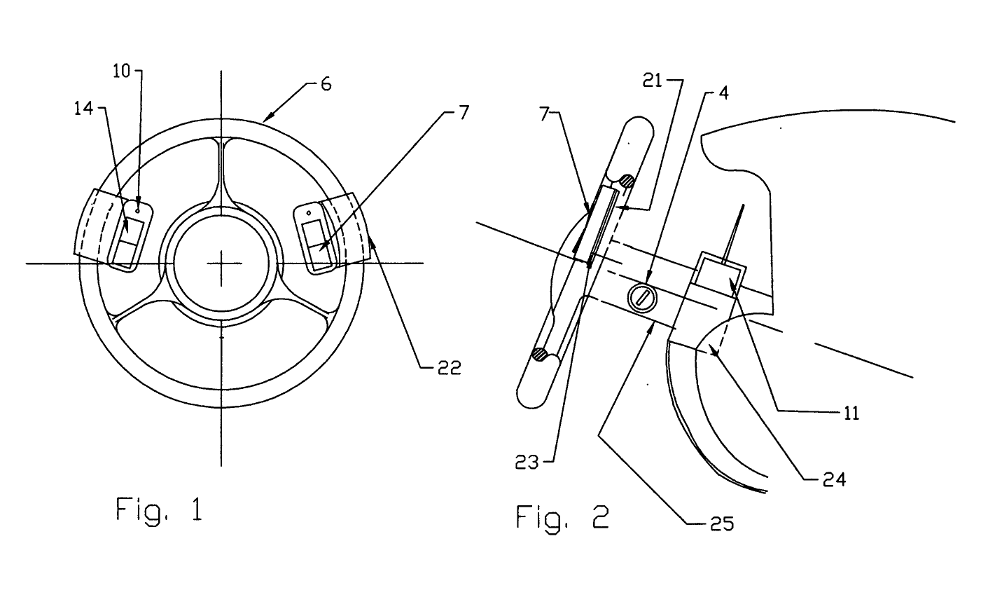

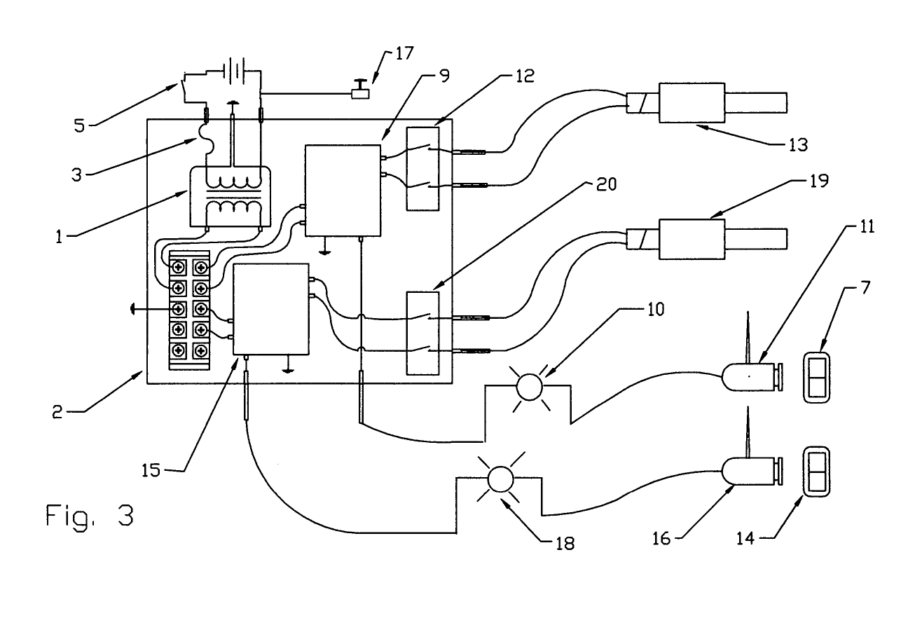

The IR Remote Plow Control has features built in to make it reliable and safe during operation, such as a transformer (FIG. 3; Item 1). This transformer is intended to keep the 9 to 12 volts consistent to ensure that the Main Control System Box (FIG. 3; Item 2) does not fail due to a difference in power from the load being put on the vehicle battery during plowing. There is also a protective override fuse (FIG. 3; Item 3) which will protect the unit from any failure in the system or vehicle. This fuse is a protection required by UL (Underwriter Laboratories) so that all electrical or electronics systems have a fuse protection. The IR Remote Transmitters (FIG. 1; Item 7 and 14) are mounted on the inside curvature of the steering wheel (FIG. 2; Item 21) with a thick Velcro. The IR Remote Transmitter is then put in a position of stiffness on the steering wheel a shown in (FIG. 2; Item 23). This parallelism will ensure easy access by the driver. The IR Remote Receiver antennae are attached to a yoke and put over a steering column as shown in (FIG. 2; Item 24) and are rested over the steering column (FIG. 2; Item 25).

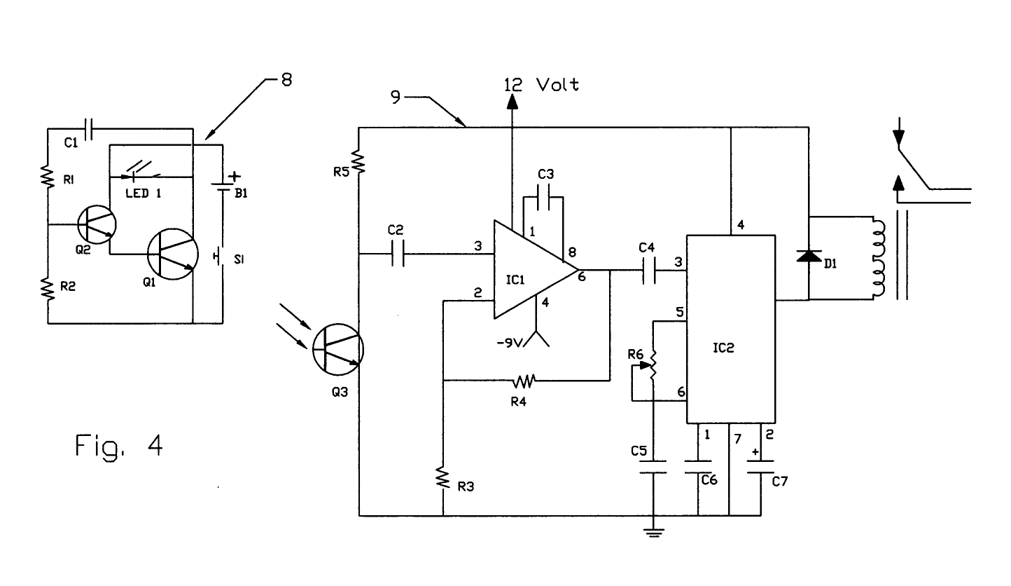

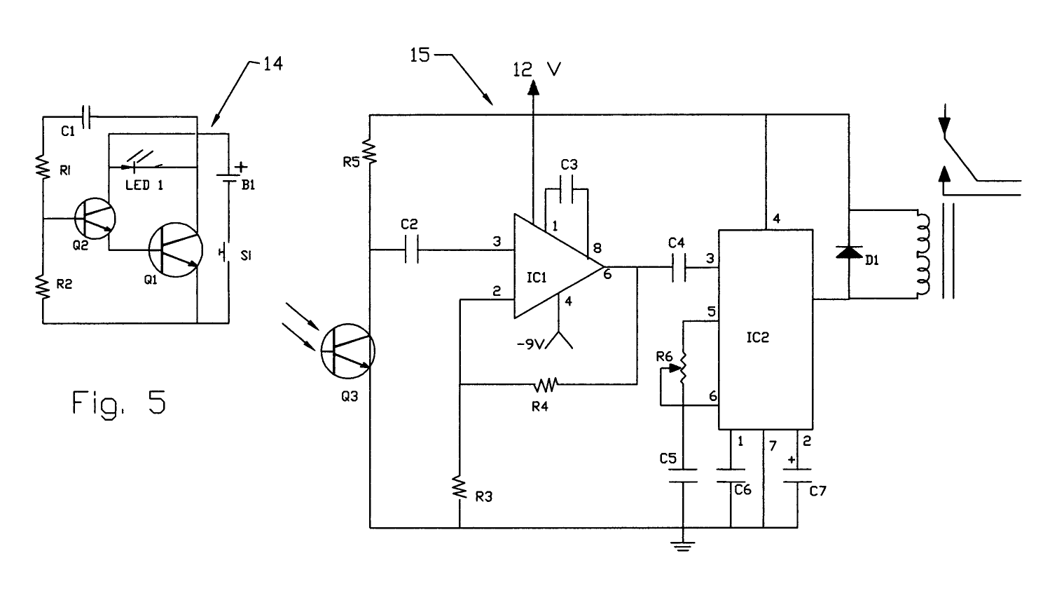

In operating the IR Remote Plow Control, when the driver or the operator starts the vehicle with the ignition (FIG. 2; Item 4), it will close the switch (FIG. 3: Item 5). This will activate the Main Control System Box (FIG. 3; Item 2). At the time of activation, the plow or any front-loading mechanism will be in the upper position, since this is the position the servo motors lock themselves in when the ignition is turned off. Once the driver is in the position that he wants to use the IR Remote Plow Control, he keeps his hands on the steering wheel of the vehicle (FIG. 1; Item 6) as he normally would during his regular driving. When the driver wants to lower the plow or front-loading mechanism, he pushes the top of the right IR button (FIG. 1, FIG. 3 & FIG. 2; Item 7) (Electronic configuration FIG. 4; Item 8) on the steering wheel. Both of these commands will send a frequency signal to the Command IR Receiver (FIGS. 3 & 4; Item 9) through the receiving antenna (FIGS. 2 & 3; Item 11) and the LED light (FIGS. 1 & 3; Item 10) will flash on, indicating that the IR sensor is working. When the driver is ready to lower the plow or front-loading mechanism, he then pushes the IR button (FIGS. 1 & 2; Item 7) on the bottom side. The LED (FIGS. 1 & 3; Item 10) will then light up, indicating that the IR sensor is activated to raise the plow or front loading mechanism. These displays signal whether to lower or raise the plow or front-loading mechanism and will then send an electrical signal to the relay (FIG. 3; Item 12) (FIG. 3; Item 20 is the relay for the right to left movement) which in turn sends the signal to the servo motor (FIG. 3; Item 13). These (2) relays (Item 12, and 20) are 12-volt magnetic relays for N.O. (normally open) circuits when not actuated. The servo motor initiates lowering or raising the plow or front-loading mechanism.

To move the plow or front-loading mechanism from right to left with the IR Remote Plow Control, the procedure is the same as the movement of the plow or front-loading mechanism for the up and down movement (as indicated above). The IR Transmitter (FIG. 1, 3 & 5; Item 14) and the IR Receiver with the receiver antenna (FIG. 3, Item 16) that are used to move the plow or front-loading mechanism from right to left (FIGS. 3 & 5; Item 15) are also identical to the IR Transmitter and IR Receiver used to raise and lower the plow or front-loading mechanism. There is also an LED light (FIG. 3; Item 18) to indicate the right and left movement of the plow or front-loading mechanism.

When the driver of the vehicle has completed his plowing and is in transit on the highway, or just moving the vehicle around, he can disable the IR Remote Plow Control by disengaging the Emergency Button (FIG. 3; Item 17), which will close down all electrical current to the IR Remote Plow Control. At this point, the servo motors (FIG. 3, Item 13 & 19) will automatically return to their idle position and lock the plow or front-loading mechanism in the upper position. The servo motors for the right to left position will also return to a neutral position, locking the front-loading mechanism or plow.

### DESCRIPTION OF THE DRAWING

1. FIG. 1 shows the front view of what the IR Remote Plow Control panel would look like from the driver's perspective. It show where the LED lights would be lighting up, where the (2) IR Transmitters are in relation to the steering wheel, and the convenience of the Transmitters for driver usage.

2. FIG. 2 shows the side view of FIG. 1 which gives the perspective of how the (2) IR Transmitters and the (2) IR Receivers are mounted.

3. FIG. 3 indicates the electrical and the mechanical layout of the IR Remote Plow Control for the purpose of explaining the connection and the function of all the various components.

4. FIG. 4 shows the electrical circuit drawing of the components that make up the IR Transmitter and IR Receiver for the up and down movement of the IR Remote Plow Control.

5. FIG. 5 shows the electrical circuit drawing of the components that make up the IR Transmitter and IR Receiver for the left to right movement of the IR Remote Plow Control.

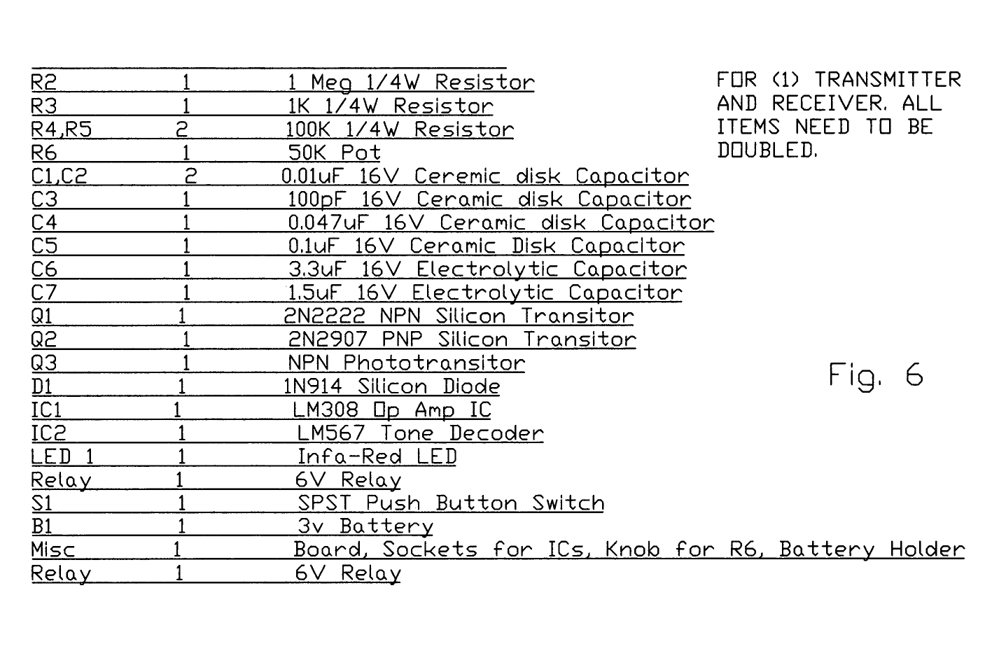

6. FIG. 6 is a partial list of the electrical/electronic items that make up the (2) IR Transmitters and the (2) IR Receivers for the IR Remote Plow Control.

I claim:

1. The only Infra-red transmitting device that operates on a frequency to move a plow or front-loading mechanism. The frequency is transmitted from the IR transmitter to the IR Receiver through an electrical system to a servo motor resulting in moving a mechanical part.

2. The only Infra-red transmitting device that can be operated by the driver without taking his hands off the steering wheel while operating the device, having the ability to move a plow or a front loaded mechanism without moving a mechanical device.

3. The only infra-red transmitting device that has an electrical box that is setup to act as the Central Processing Unit (CPU) that can process the signal remotely and get a mechanical item to move a plow or a front-moving mechanism.
